(19) United States
(12) Patent Application Publication
(10) Pub. No.: US 2021/0398135 A1
(43) Pub. Date: Dec. 23, 2021

(54) DATA PROCESSING AND TRANSACTION DECISIONING SYSTEM

(71) Applicant: ID Metrics Group Incorporated, Kirkland, WA (US)

(72) Inventor: Richard Austin Huber, JR., Weehawken, NJ (US)

(21) Appl. No.: 17/354,791

(22) Filed: Jun. 22, 2021

Related U.S. Application Data
(63) Continuation of application No. 63/042,445, filed on Jun. 22, 2020.

(51) Int. Cl. G06Q 20/40; G06Q 10/10; G06Q 50/26; G06N 20/00; G06K 9/00; G06K 9/62

(52) U.S. Cl. CPC G06Q 20/40145; G06Q 10/10; G06K 9/6217; G06N 20/00; G06K 9/00456; G06Q 50/265

(57) ABSTRACT

Methods, systems, and computer programs for transaction verification. In one aspect, a transaction verification system having a plurality of transaction verification modules that have each been trained to generate output data indicating whether data associated with a transaction should be denied, generating a transaction profile based on the output data generated by each of the transaction verification modules, determining, based on the transaction profile, whether the transaction should be denied, based on determining that the transaction should not be denied, selectively storing the data associated with the transaction in a database for review by a human user, receiving input data from the human user, the input data indicating that the image of the identification document has a characteristic of a transaction that should be denied, and dynamically training the transaction verification system to identify subsequent transaction data that has the characteristic as identifying a person whose transaction should be denied.

### CROSS-REFERENCE TO RELATED APPLICATION

This application claims the benefit under 35 U.S.C. § 119(e) of U.S. Patent Application No. 63/042,445, entitled “DATA PROCESSING AND TRANSACTION DECISIONING SYSTEM,” filed Jun. 22, 2020, which is incorporated herein by reference in its entirety.

### BACKGROUND

Conventional fraud detection systems can be designed to detect one or more transactions that are to be denied. These systems can trigger alerts that cause one or more transactions to be denied based on one or more attributes of a party to the transaction, one or more attributes of the transaction, or a combination of both.

### SUMMARY

According to one innovative aspect of the present disclosure, a method for transaction verification is disclosed. In one aspect, a method can include actions of obtaining, by the data processing system, first data representing user identification information, the user identification information comprising an image of an identification document, providing, by the data processing system, the first data as an input to a transaction verification system, the transaction verification system comprising one or more transaction verification modules that have each been trained to generate output data indicating whether data representing at least a portion of an input image depicts an identification document of an actor whose transaction is to be denied, generating, by the data processing system, a transaction profile based on the output data generated by the transaction verification system, determining, by the data processing system and based on the transaction profile, whether the transaction is to be denied, based on determining, by the data processing system and based on the transaction profile that the transaction is not to be denied, selectively storing, by the data processing system, the user identification information in a database for review by one or more human users, receiving, by the data processing system, input data from the one or more human users, wherein the input data indicates that the image of the identification document has a characteristic of a transaction that is to be denied, training, by the data processing system, the transaction verification system to identify subsequent user identification information that has the characteristic as identifying a person whose transaction is to be denied.

Other versions include corresponding systems, apparatuses, and computer programs that are configured to perform, or otherwise realize, the actions of methods defined by instructions encoded on one or more computer readable storage devices.

These and other versions may optionally include one or more of the following features. For instance, in some implementations, the identification document is a document that can include an image of a person. In such implementations, the image can include (i) a driver's license, (ii) a passport, or (iii) other document that depicts an image of the person or other information that can identify the person.

In some implementations, the user identification information can include one or more of a selfie image, device data, biometric information, or behavioral information.

In some implementations, selectively storing, by the data processing system, the user identification information in a database for review by one or more human users can include determining, by the data processing system, that at least one value in the transaction profile is within a predetermined range for review, and based on determining, that the at least one value is within the predetermined range for review, storing the user identification information in the database for review by one or more human users.

In some implementations, training, by the data processing system, the transaction verification system to identify subsequent user identification information that has the characteristic as a transaction that is to be denied can include adjusting a threshold of the machine learning model based on a difference between the threshold and the predetermined range for review.

In some implementations, selectively storing, by the data processing system, the user identification information in a database for review by one or more human users can include determining, by the data processing system, that there is not at least one value in the transaction profile that is within a predetermined range for review, and based on determining that there is not at least one value in the transaction profile that is within the predetermined range for review, determining to not store the user identification information in the database for review by one or more human users.

These and other aspects of the present disclosure are discussed in more detail in the detailed description below with reference to the accompanying drawings.

### BRIEF DESCRIPTION OF THE DRAWINGS

FIG. 1 is a contextual diagram of an example of a transaction decisioning system.

FIG. 2 is a flowchart of an example of a process of dynamically re-training a transaction verification system of a transaction decisioning system.

FIG. 3 is a block diagram of system components that can be used to implement a flexible transaction verification system.

### DETAILED DESCRIPTION

The present disclosure is directed towards a method, system, and computer program, for a transaction decisioning system. The transaction decisioning system includes a transaction verification system that can be precisely tailored to the business model of a particular business. The transaction verification system can be tailored through selection and deployment of one or more transaction verification modules from a pool of available transaction verification modules using a software as a service (SaaS) software distribution model. The transaction verification system can then be dynamically retrained in real-time to adapt to strategies developed by bad actors to beat an already deployed transaction verification system. As a result, the transaction verification system can be trained learn and identify new strategies employed by bad actors over time and evolve so that the transaction verification system can reduce fraudulent transactions carried out using these new strategies employed by bad actors over time.

Dynamic retraining of the transaction verification system can be achieved by first identifying transaction profiles that are candidate transaction profiles for review. A candidate transaction profile can be detected by, for example, determining that one or more scores of a generated transaction profile falls within a predetermined amount of error to one or more custom thresholds set for transaction profile scores. Once detected, the candidate transaction profiles can be stored for human review.

In some implementations, the transaction verification system can receive an instruction from a user that the candidate transaction profile is an example of a transaction profile that represents a transaction that is to be denied in the future. In response to the received instruction, the transaction verification system can be dynamically retrained in real-time to recognize future transactions that produce a transaction profile that corresponds to the candidate transaction profile as a transaction that is to be denied. This dynamic retraining improves the accuracy of the transaction verification system in identifying subsequent fraudulent transactions that may be initiated by a bad actor in the future.

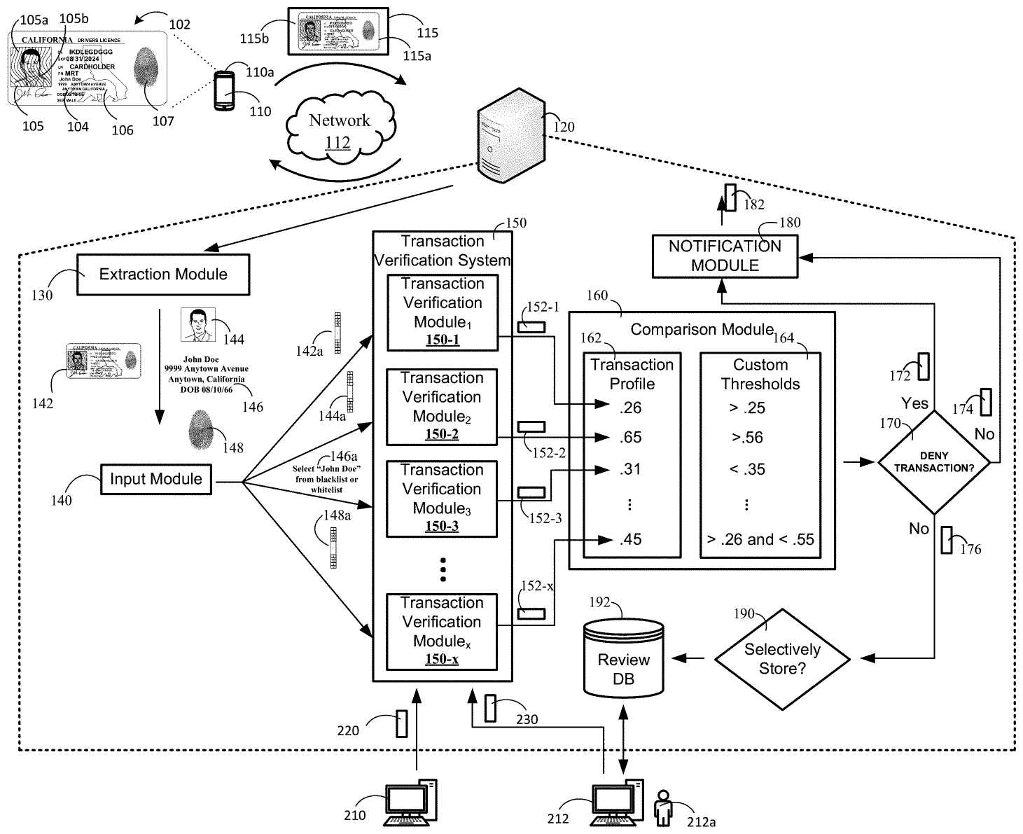

FIG. 1 is a contextual diagram of an example of a transaction decisioning system 100. In general, the transaction verification system 100 can include a user device 110, a verification server 120, and one or more networks 112. However, in some implementations, the transaction decisioning system 100 can also include a first computer 210 for configuring the transaction verification system 150 to a particular business model, a second computer 212 that can be used to instruct the transaction verification system 150 to dynamically retrain itself, or a combination of both.

The verification server 120 can include an extraction module 130, an input module 140, a transaction verification system 150, a comparison module 160, a notification module 180, and a review database 192. In some implementations the verification server 120 can include a single computer that includes each of the extraction module 130, the input module 140, the transaction verification system 150, the comparison module 160, the notification module 180, and the review database 192. In other implementations, the verification server 120 can include multiple different computers that are configured to communicate, via one or more networks such as network 112, with each of the one or more computers hosting one or more of extraction module 130, the input module 140, the transaction verification system 150, the comparison module 160, the notification module 180, and the review database 192. In yet other implementations, each of the respective modules or databases can be distributed across multiple different computers that are configured to communicate via one or more networks such as network 112.

For purposes of this disclosure, the term “module” can include software instructions, one or more hardware components, or any combination of software instructions and one or more hardware components necessary to realize the operations described by the software instructions. Moreover, it is understood that one skilled in the art could, given the description of the functions of each module described by this specification, generate software instructions that, when executed by one or more hardware components such as one or more central processing units, one or more graphical processing units, or a combination thereof, realize the functionality of the modules described by this specification.

Prior to using the verification server 120 to verify one or more transactions, a first computer 210 can be used to configure the transaction verification system 150. For example, the first computer 210 can be used to configure the transaction verification system 150 to verify transactions related to a particular business model of a business. In some implementations, the first computer 210 can configure the transaction verification system 150 by generating and providing one or more instructions 220 to the transaction verification system 150 to enable access or disable access one or more transaction verification modules 150-1, 150-2, 150-3, 150-x, where x is any non-zero integer greater than 0. In such implementations, the transaction verification server 150 may include each of a plurality of transaction verifications modules offered by a verification server 120 for transaction verification. In other implementations, the computer 210 can generate and provide one or more instructions to the transaction verification system 150 that cause computer resources to be allocated that cause the transaction verification system 150 to be configured to include a particular subset of transaction verification modules 150-1, 150-2, 150-3, 150-x offered by a transaction verification provider for verifying transactions. In these implementations or other implementations, the transaction verification system 150 can be dynamically configured with a particular set of transaction verification modules that are customized to verify transactions related to a particular entity's business model. Different business models can include user device sales or rentals, financial transactions, in person point-of-sale purchases, online purchases, real estate transactions, or the like.

The one or more transaction verification modules 150-1, 150-2, 150-3, 150-x can be one or more computing applications that can be hosted by the verification server 120 and made available to end users such as a user of the user device 110. The one or more transaction verification modules 150-1, 150-2, 150-3, 150-x can include or more of a physical identification document verification model, a facial recognition verification module, a personal information verification module, a biometric verification module, a velocity verification module, a liveness verification module, or any other type of verification module.

By way of example, the one or more transaction verification modules 150-1, 150-2, 150-3, 150-x can include a physical identification document verification module 150-1. The physical identification document verification module can be used to evaluate a physical identification document of a party to a transaction. The physical identification document verification module can include one or more machine learning models that are trained to predict a likelihood 152-1 that an image of a physical identification document depicts a counterfeit document. For example, the physical identification document verification module can receive, as an input, an image of a physical identification document such as a driver's license, passport, birth certificate, or the like, and determine, based on processing of the image of the physical identification document a likelihood that the image of the physical identification document depicts a counterfeit document.

For example, the physical identification document verification module can be trained to detect the presence or absence of security features in an image of the physical identification document. If the physical identification document verification module determines that one or more security features of an anticounterfeiting architecture upon which the physical document verification module has been trained are not depicted by the image of the physical identification document, then the physical identification document verification module can generate output data indicating that the image of the physical identification document likely depicts a counterfeit document. Alternatively, if the physical identification document verification module determines that each security feature of an anticounterfeiting architecture are depicted by an image of a physical identification document, then the physical identification document verification module can generate output data indicating that the image of the physical identification document likely depicts an image of a legitimate physical identification document.

For purposes of this specification, an “anticounterfeiting architecture,” can include a group of two or more anticounterfeiting security features whose presence in a physical identification document indicate that a physical identification document is legitimate. “Security features” of an anticounterfeiting architecture is a term that refers to a component of an anticounterfeiting architecture whose presence or absence in an image of a physical document can be detected by a machine learning model trained in accordance with the present disclosure. By way of example, a machine learning model trained in accordance with the disclosure can detect an absence of a security feature where it should exist, presence of a security feature where it should not exist, incorrect security features, abnormal security features, natural background, artificial background, natural lighting, artificial lighting, natural shadow, artificial shadow, absence of flash shadow such as a drop shadow, head size abnormalities, head aspect ratio abnormalities, head translation abnormalities, abnormal color temperatures, abnormal coloration, aligned and configured flash lighting, off-angle illumination, focal plan abnormalities, bisection of a focal plane, use of fixed focal length lenses, imaging effects related to requanitization, imaging effects related to compression, abnormal head tilt, abnormal head pose, abnormal head rotation, non-frontal facial effects, presence of facial occlusions such as glasses, hats, head scarfs, or other coverage, abnormal head shape dynamics, abnormal head aspect ratio to intereye distances, abnormal exposure compensation between foreground and background, abnormal focus effects, image stitching effects indicating different digital sources, improper biometric security feature printing, improper security feature layering such as improper OVD, OVI, hologram, other secondary security feature overlays over a face or other portion of a document, improper tactile security feature placement near face, over a face, or other portion of a document, improper final face print, improper laser black and white, improper color laser, improper layered ink print, improper printing techniques, improper print layer sequencing, or the like.

By way of another example, the one or more transaction verification modules 150-1, 150-2, 150-3, 150-x can include a facial recognition module 150-2. The facial recognition module be used to evaluate an input image of a face of an entity that is a party to a transaction. For example, the facial recognition module can compare the input image of the face of the entity that is a party to a transaction to a database of facial images and determine based on the comparison a likelihood 152-2 that the transaction sought by the entity is legitimate. The database of facial images can include a good-actor list of facial images indicating a list of entities whose transactions are to be approved, a bad-actor list of facial images of entities whose transaction are to be denied, or a combination of both. The likelihood that the transaction sought by the entity is legitimate can be based on the similarity of the input image to a facial image of one or more persons associated with one or more of the lists.

In some implementations, for example, the image of the person can represented by an input vector. The facial recognition module can be configured to compare the input vector to a respective vector associated with good-actor list. If the input vector is determined to satisfy as threshold level of similarity to one or more vectors representing facial images associated with the good-actor list, then the facial recognition module can generate output data indicating that the likelihood that the transaction is legitimate is high. Alternatively, if the input vector is determined to not satisfy the threshold level of similarity to one or more vectors on the good-actor list, then the facial recognition module can compare the input vector to one or more vectors representing facial images associated with a bad-actor list. If the input vector is determined to satisfy a threshold level of similarity to one or more vectors on the bad-actor list, then the facial recognition module can generate output data indicating that the likelihood that the transaction is legitimate is low. Alternatively, if the input vector is determined to not satisfy a threshold level of similarity to any vectors on the good-actor list or the bad-actor list, then the facial recognition module can generate output data that is not alone dispositive as to whether or not the transaction sought by the entity is legitimate.

By way of another example, the one or more transaction verification modules 150-1, 150-2, 150-3, 150-x can include a personal information verification module 150-3. The personal information verification module can obtain personal information such as text information describing a name of an entity that is a party to a transaction, an address of an entity that is a party to a transaction, a gender of an entity that is a party to a transaction, a birthdate of an entity that is a party to a transaction, a social security number of an entity that is a party to a transaction, a driver's license number of an entity that is a party to a transaction, or the like. The personal information verification module can perform one or more search queries against one or more databases using the one or more portions of the obtained personal information as keywords of the search queries.

For example, the personal information verification module can perform a name search of customers who have defaulted on a payment in the last 90 days. The personal verification module can determine, based on the search, whether an entity having the same name as the entity that is a party to a transaction has defaulted on one or more prior payments in the last 90 days. If it is determined by the personal information verification module that the name search indicates that an entity with the same name has previously defaulted on one or more payments in the last 90 days, then the personal information verification module can generate output data indicating that the likelihood that the transaction is to be denied is higher than a scenario where the entities name did not match any name stored in the database of names of entities who have defaulted on one or more payments in the last 90 day. Likewise, if it is determined by the personal information verification module that the name search indicates that an entity with the same name has not previously defaulted on one or more payments in the last 90 days, then the personal information verification module can generate output data indicating that the likelihood that the transaction is to be permitted is higher than a scenario where the entity name did appear to match at least one name stored in the database of names of entities who have defaulted on one or more payments in the last 90 day.

By way of another example, the personal information verification module can check the credit score of an entity that is a party to a transaction by performing one or more searches that include a social security number, a birth date, or both, of the entity that is a party to the transaction. In some implementations, this information can be extracted from an image of physical identification document presented by an entity to a transaction. In such instances, if the personal information verification module determines that the credit score for the entity obtained using the social security number, birth date, or both, fails to satisfy a predetermined threshold, then the personal information verification module can generate output data indicating that the likelihood that the transaction is to be denied is higher than a scenario where the entity's credit score did satisfy the predetermined threshold. Likewise, if the personal identification verification module determines that the credit score for the entity satisfies a predetermined threshold, then the personal information verification module can generate output data indicating that the likelihood that the transaction is to be approved is higher than a scenario where the entity's credit score fails to satisfy a predetermined threshold.

For purposes of the present disclosure, a value such as a credit score can be determined to satisfy a threshold if it is above the threshold or below the threshold. Whether the value must be above the threshold or below the threshold is determined by the configuration of a particular system. For example, the personal information verification module 150-3 can be trained to detect credit scores above 700. In such instances, the system can be configured to determine that a score of 700 satisfies a threshold by detecting credit scores greater than 699. In other implementations, the system can likewise be configured to determine that a score of 700 satisfies a threshold by inverting the credit score to −700 and determining that the credit score is less than −699. These are examples provided only to illustrate the meaning of satisfying a threshold and are not otherwise intended to limit other features of the present disclosure.

In some implementations, the personal information verification module 150-3 can generate output data 152-3 that represents a score as to whether a transaction should be denied or permitted based on the results of the personal information search. Whether or not results of a personal information search indicate that a transaction should be denied may be completely customizable. For example, the personal information verification module may be configured to generate output data 150-3 that indicates a likelihood that a transaction is to be denied if an entity that is party to the transaction has a credit score that falls below a certain threshold, has a name that is on a list of entities that has defaulted within the last 90 days, the like, or a combination thereof. Alternatively, the personal information verification module may be configured to generate output data 150-4 that indicates a likelihood that a transaction is to be allowed if an entity that is a party to a transaction has a credit score that is above a certain threshold, does not have a name that is on a list of entities that have defaulted within the last 90 days, or a combination thereof.

By way of another example, the one or more transaction verification modules 150-1, 150-2, 150-3, 150-x can include a biometric verification module 150-x. The biometric verification module can be configured to receive biometric information from the input module 140 and perform one or more searches of one or more biometric databases based on the received biometric information. For example, in some implementations, the portion 115a of the image of the physical document 102 that is extracted by the extraction unit 130 can include a depiction of a fingerprint. In such an implementation, the input module can identify the image of the fingerprint and generate input data 148a that represents the fingerprint for input to the transaction verification module 150-x. In this example, the transaction verification module 150-x can search one or more biometric databases storing data representing different fingerprints to determine a level of similarity between the input data 148a and each of the stored fingerprints.

The biometric verification module 150-x can generate output data 152-x that represents a score as to whether a transaction should be denied or permitted based on the results of the biometric search. Whether or not results of the biometric search indicate that a transaction should be denied may be completely customizable. For example, the biometric verification module may be configured to generate output data 152-x that indicates that a transaction is likely to be denied if the input data 148a representing a fingerprint matches, within a predetermined level of similarity, data representing a fingerprint in a biometric database searched by the biometric verification module 150-x. Alternatively, the biometric verification module may be configured to generate output data 152-x that indicates that a transaction is likely to be allowed if the input data 148a representing the fingerprint does not match, within a predetermined level of similarity, data representing a fingerprint in the biometric database searched by the biometric verification module 150-x.

By way of another example, the one or more transaction verification modules 150-1, 150-2, 150-3, 150-x can include a velocity verification module. A velocity verification module can include a verification module that is configured to generate output data that indicates whether a transaction is to be denied based on consultation with a collaborative verification system. The collaborative verification system can be a processing system that maintains a collaborative bad-actor list constructed using bad-actor data from different enterprises that have entered into an agreement to share data describing bad actors, data describing transactions of bad actors, or a combination thereof.

For example, if a first enterprise detects a transaction attempted or completed by a bad actor, the first enterprise can add data describing the bad actor to the collaborative bad-actor list. Then, if the bad actor attempts any transaction or a similar transaction at a second enterprise that participates in the velocity system, the second enterprise can check the collaborative bad actor list before completing the transaction, detect information identifying the bad actor or the bad actor's transaction on the collaborative bad-actor list, and deny the transaction.

In some implementations, if it is determined, by the velocity verification module, that data identifying an entity that initiated a transaction or data identifying a similar transaction to the current transaction is stored by the collaborative bad-actor list, then the velocity verification module can generate output data indicating that the transaction is likely a transaction that is to be denied and the generated output data can be aggregated by the verification server 120 along with the outputs of other transaction verification modules for use in generating a transaction profile 162. Alternatively, if it is determined, by the velocity verification module, that data identifying an entity that initiated the transaction or data identifying a similar transaction to the current transaction is not stored by the collaborative bad-actor list, then the velocity verification module can generate output data indicating that the transaction is likely a transaction that is to be allowed and the generated output data can be aggregated by the verification server 120 along with the outputs of other transaction verification modules for use in generating a transaction profile 162.

By way of another example, the one or more transaction verification modules 150-1, 150-2, 150-3, 150-x can include a liveness verification module. The liveness verification module can be configured to receive, as an input, data describing a video or image and determine, based on the video or image, whether the image depicts a real person or a fake person. A determination as to whether a real person or a fake person is depicted in the image can be made based on the output of the liveness verification module.

For example, if it is determined, by the liveness verification module, that an image depicts a fake person, then the liveness verification module can generate output data indicating that the transaction is likely a transaction that is to be denied and the generated output data can be aggregated by the verification server 120 along with the outputs of other transaction verification modules for use in generating a transaction profile 162. Alternatively, if it is determined, by the liveness verification module, that an image depicts a real person, then the velocity verification module can generate output data indicating that the transaction is likely a transaction that is to be allowed and the generated output data can be aggregated by the verification server 120 along with the outputs of other transaction verification modules for use in generating a transaction profile 162.

Functionality of the system 100 can be described with reference to FIG. 1. In the example of FIG. 1, an entity such as a human that is party to a transaction, can initiate a transaction. The transaction can include a user device purchase or rental, a financial transaction, a request to open a bank account, a point of sale purchase, a real estate transaction, a request to enter a restaurant or bar, a request to pass through a gate at a security terminal, a response to a request for identification, or the like. During the transaction, the entity can present the physical identification document 102 for verification. The physical identification document 102 can include one or more personally identifiable features, one or more security features, or a combination of both. In this example of FIG. 1, the physical identification document 10 can include personally identifiable information such as a profile image, an address, or the like. Similarly, in this example, the physical identification document 102 can include security features such as guilloche lines 105a over at least a portion of the physical identification document 102, a drop shadow 105b behind the head depicted in by the profile image 105, a graphic 106, biometric information 107, or the like. Thus, the physical identification document 102 in FIG. 1 includes a combination of personally identifiable features and security features.

A user device 110 can be used to capture an image of the physical identification document 102. For example, the camera 110a of the user device 110 can be used to generate an image 115 of the physical identification document 102. The image 115 can include a first image portion 115a and a second image portion 115b. The first image portion 115a depicts an image of the physical identification document 102. The second image portion 115b depicts a portion of the background environment that was included in the image 115 when the user device 110 was used to generate the image 115. The user device 110 can transmit the image 115 to the verification server 120 via the network 112. The network 112 can include a wireless network, a wired network, an Ethernet network, an optical network, a LAN, a WAN, a cellular network, the Internet, or any combination thereof. The verification server 120 can receive the image 115 and provide the image 115 as an input to the extraction module 130.

The extraction module 130 can be configured to receive the image 115 and extract one or more portions of the image 115 for further processing. In some implementations, extracting one or more portions of the image 115 can include extracting the first image portion 115a from image 115 and discarding the second image portion 115b. In some implementations, extracting one or more portions of the image 115 can include extracting different portions of the image 115 that can be provided as respective inputs to different transaction verification modules 150-1, 150-2, 150-3, 150-x of the transaction verification system 150. In such implementations, the extraction module 130 can extract different portions of the image 115 such as the first image portion 115a, a profile image 144, personal information 146, biometric information, or any other information depicted by the image 115.

In yet other implementations, the extraction module 130 can receive and process other information received from the user device 110. For example, in some implementations, the user device 110 may be a device of the entity that is a party to the transaction, and the user device 110 can obtain video data, image data, or both, that can be used as an input to a liveness detection transaction verification module. In such implementations, the user device 110 can capture, for example, video data of the entity using one or more cameras of the user device 110 that can be provide, as an input, to a liveness detection transaction verification module. In such instances, the extraction module 130 can receive the video data, image data, or both, extract a subset of the video data, image data, or both, such as one or more particular frames of the video data or image data, and provide the extracted video data, extracted image data, or both, as an input to the input module 140, which can process the received video data, image data, or both, to generate input data for a liveness transaction verification module. Such a liveness transaction verification module may be configured to receive for example, one or more videos of a particular duration, one or more image frames, or a combination thereof which can be generated by the extraction module 130.

The image portions 142, 144, 146, 148 extracted from the image 115, by the extraction module 130, can be provided to the input module 140 as an input. The input module 140 can be configured to analyze each item of content it receives and generate, for each content item, input data for a respective transaction verification module that corresponds to the content item. In some implementations, this may include generation of an input vector, bitmap, or other data structure that is a representation of the information extracted from the image 115 that can be processed by one or more of particular machine learning models. In other implementations, input data generated by the input module 140 for input to one or more transaction verification modules 150-1, 150-2, 150-3 can include a query. For example, in some implementations, the input module 140 can receive a portion of an image 115 that depicts personal information that is in text form. In such instances, the input module 140 can obtain the textual from the received portion of the image 115 and generated a query using the obtained text. The text can be obtained, for example, using optical character recognition (OCR) techniques. In other implementations, the extraction module 130 may perform text extraction operations described above with respect to the input module 140 and then provide the extracted text to the input module 140 for use in generating a query.

Queries generated by the input module 140 need not be limited to queries with text parameters. For example, in some implementations, the input module can generate image queries based on, for example, a profile image 144 extracted by the extraction module 130. In some implementations, a vector representation of the profile image can be generated, with each field of the vector including a numerical value that corresponds to a pixel of the image 144. In such implementations, the generated vector 144a can be provided to a transaction verification module such as facial recognition search module 150-2 for facial recognition search and analysis. Other representations of the image 144 or other images can be generated by the input module 140 for input into a machine learning model, search algorithm, or other form of transaction verification module.

The transaction verification system 150 can receive input data 142a that includes an input vector that represents input image 142 which may, e.g., by the same as the first image portion 115a, input data 144a that includes a facial recognition query based on a profile image 144 extracted from the first image portion 115a, input data 146a that includes a text query based on the personalized information 146, and input data 148a that includes a biometric query based on the biometric information 148. The transaction verification system 150 can use respective transaction verification module 150-1, 150-2, 150-3, 150-x to process input data 142a, 144a, 146a, 148a in order to generate output data 152-1, 152-2, 152-3, 152-x. The generated output data 152-1, 152-2, 152-3, 152-x can each include an indication, generated the respective transaction verification module 150-1 that produced the output, that the transaction is to be permitted.

For example, the transaction verification module 150-1 can include a machine learning model that generates output data 152-1 that is indicative of whether or not the transaction sought is to be approved based on the machine learning mode used by transaction verification module 150-1 processing the input data 142a. By way of another example, the transaction verification module 150-2 can include a facial recognition search algorithm that generates output data 152-2 that is indicative of whether or not the transaction sought is to be approved based on results of a search of a facial recognition database using the input data 144a. By way of another example, the transaction verification module 150-3 can include a personal information search module that generates output data 152-3 that is indicative of whether the transaction sought is to be approved based on whether search results from searches of one or more databases based on the input data 146a matches or does not match, within a threshold level of error, one or more records in the one or more searched databases. By way of another example, the transaction verification module 150-3 can include a biometric search module that generates output data 152-x that is indicative of whether the transaction sought is to be approved based on whether search results from searches of one or more biometric database based on the input data 148a matches or does not match, within a threshold level of error, one or more records in the one or more searched biometric databases.

The generated output data 152-1, 152-2, 152-3, 152-x can be aggregated by the verification server 120 to create a transaction profile 162. The transaction profile 162, when viewed in isolation, is essentially raw data generated by the transaction verification system 150 based on each of the respective transaction verification modules 150-1, 150-2, 150-3, 150-x processing the respective input data items 142a, 144a, 146a, 148a, which each relate to a particular factor or attribute of the transaction. As a result, the transaction profile 162 does not necessarily, in complete isolation, inform whether the transaction sought is to be approved or denied. However, the verification server 120 can employ a comparison module 160 to use a set of custom thresholds 164 to interpret the transaction profile 162 so that the system 100 can determine whether the transaction sought is to be approved or denied.

Custom thresholds 164 can be initialized using default values. Then, a user such as user 212a can use a computer 212 to train the transaction verification system 150 and adjust custom thresholds 164 as necessary. For example, the user 212a can begin to train the transaction verification system 150 by providing input data such as an image of an identification document to the verification server 120 that is labeled as having one or more features that are legitimate, one or more features that are not legitimate, or a combination thereof. The user 212a can review the output data 152-1, 152-2, 152-3, 152-x generated by each respective transaction verification module 150-1, 150-2, 150-3, 150-x in view of the initial custom thresholds and determine whether the output data satisfies the currently established customer thresholds. If the output data generated by the 152-1, 152-2, 152-3, 152-x does not satisfy the appropriate thresholds, as currently set, the user 212a can use the computer 212 to adjust the threshold so that the output data generated by each of the respective transaction verification modules 150-1, 150-2, 150-3, 150-x satisfies each of the respective thresholds. The user 212a can iteratively perform the aforementioned process to adjust values of each particular thresholds of the custom thresholds 164 until the verification server 120 accurately classifies transaction profiles 162 generated for each training image provided as an input to the transaction verification server 120.

Each particular threshold of the custom thresholds 164 can be configured using any transaction verification rule designed to evaluate the output of a transaction verification module. By way of example, each threshold of the custom thresholds can include a rule evaluated against output data generated by a particular transaction verification module using a greater than operation, a greater than or equal to operation, an equal to operation, a less than or equal to operation, a less than operation, a range established using a combination of these operations, or the like. In some implementations, the output of a transaction verification module can be mapped, scaled, or weighted prior to applying the customized threshold to the output of the transaction verification module. In general, any type of custom threshold can be designed to evaluate the output generated by a transaction verification module.

During run time, the verification server 120 can execute decisioning logic 170 to determine whether a transaction sought by the entity that presented the physical identification document 102 as part of the transaction is to be approved or denied. The decisioning logic 170 can make this determination by evaluating the results of the comparison module's 160 application of the custom thresholds 164 to the transaction profile 162. In some implementations, the decisioning logic 170 may only determine that a transaction is to be approved if the comparison module 160 determines that all of the thresholds of the custom thresholds 164 are satisfied by the values of the transaction profile 162.

In other implementations, the decisioning logic 170 may only determine that a transaction is to be approved if the comparison module 160 determines that a predetermined number of thresholds of the custom thresholds 164 are satisfied by values of the transaction profile 162. For example, in some implementations, the decisioning logic 170 can employ “voting” model, with each transaction value and custom threshold combination yielding a “vote.” In such implementations, if a particular transaction value of the transaction profile 162 satisfies its corresponding threshold of the custom thresholds 164, then the comparison module 160 can generate output data representing a “vote” in favor of approving the transaction sought. Likewise, in such implementations, if a particular transaction value of the transaction profile 162 does not satisfy its corresponding thresholds of the custom thresholds 164, then the comparison module 160 can generate output data representing a “vote” in favor of denying the transaction sought. Then, the decisioning logic 170 can determine whether to approve or deny the transaction sought based on whether a number of approve votes satisfies a predetermined threshold. In some implementations, the predetermined threshold may include a majority of votes.

In some implementations, all “votes” may not be created equal. For example, votes from particular modules may be weighted in order to give the particular “vote” more or less of an impact. In some implementations, the decisioning logic 170 can be configured such that only a single vote must be in favor of approving the transaction sought in order for an approval of the transaction to be granted. For example, the comparison module 160 can be configured to require output from a personalized information transaction verification module 150-3 to result in a vote for approval of the transaction in order to have the transaction approved. This is because such a search may indicate that the entity that is a party to the transaction has a credit score that satisfies a predetermined threshold, the entity does not have a name that appears on a bad-actor list, or a combination thereof. In other implementations, the decisioning logic 170 may only determine that the transaction sought is to be approved if a predetermined number of approval votes satisfies a predetermined threshold and the personalized information transaction verification module 150-3 has voted in favor of approving the transaction. In such an implementation, the decisioning logic 170 can determine that the transaction is to be denied in instances where a majority of “votes” support approval of the transaction sought, but the personalized information transaction verification module 150-3 votes to deny the transaction sought. The personalized information transaction verification module 150-3 is only used here as an example. Any of the other transaction verification modules of the transaction verification system can be used her as a controlling transaction verification module.

In the example of FIG. 1, the comparison module 160 can determine that each of the transaction values of the transaction profile 162 satisfy their corresponding threshold in the custom thresholds 164. Accordingly, in this example, the decisioning logic 170 can determine, using any of the methodologies described above, that the transaction sought is to be approved. In such instances, the decisioning logic 170 generate output data 172 that instructs the notification module 180 to generate and transmit a notification 182 to the user device 110 via the network 112 that causes the user device 110 to generate output data that indicates that the transaction is to be approved. The output data can include visual output rendered on the display of the user device 110 based on the user device 110 processing the notification 182, with the visual output data indicating that the transaction is to be approved. Alternatively, or in addition, the output data can include an audio output by a speaker of the user device 110 that indicates that the transaction is to be approved. Alternatively, or in addition, the output data can include haptic feedback indicating that the transaction sought is to be approved. Such haptic feedback can include the user device vibrating.

In some instances, the decisioning logic 170 can determine that the transaction sought is to be denied. In such instances, the decisioning logic 170 can generate output data 174 that instructs the notification module 180 to generate a notification that can be transmitted to the user device 110 via then network 112 and notify the user device that the transaction sought is to be denied. Like the approval notification, the denial notification can be a visual notification, an audio notification, a haptic feedback notification, or a combination thereof.

Regardless of whether the transaction sought is to be approved or denied, the transaction verification server 120 can selectively store data describing the transaction sought in a database 192 for review. For example, the verification server 120 can transmit an instruction 176 to another decisioning logic unit 190 that is configured to determine whether data describing the transaction sought is to be selectively stored. In some implementations, this instruction 176 can come from the decisioning logic 170. In other implementations, this instruction 176 can come from another component of the transaction verification server 120 such as the comparison module 160 or other component.

The decisioning logic 190 can determine whether data describing the transaction sought should be stored in the review database 192 in a number of different ways. For example, the determining logic 190 can evaluate whether one or more of the transaction values of a transaction profile for the transaction sought falls within a predetermined error threshold of its corresponding threshold in the custom thresholds 164. If, the decisioning logic 190 determines that one or more transaction values of the transaction profile 162 for the transaction sought falls within a predetermined error threshold of its corresponding threshold, then the decisioning logic 190 can determine to store data describing the transaction in the review database 192. Data describing the transaction sought can include, for example, the first image portion 115a, any of the extracted sections of the first image portion 115a used to generate input data 142a, 144a, 146a, or 148a, the transaction profile 162, the custom thresholds 164, or any other transaction metadata associated with the transaction sought.

By way of example and with reference to FIG. 1, data related to the transaction sought in the example of FIG. 1 can be stored if a first transaction value, e.g., 0.26, of the transaction profile 162 is within a predetermined amount of error, e.g., +/−0.3, of the corresponding threshold of 0.25 in the custom thresholds. Because at least one transaction value of the transaction profile 162 falls within a predetermined amount of error of its corresponding threshold of the custom thresholds 164, the verification server 120 can selectively store data related to the transaction sought in the database 192 for review. Though an example of an error threshold of +/−0.3 is described, the present disclosure is not so limited and can be set to any value based on a tolerance level determined by the designer of the system 100.

From time to time, the user such as user 212a can use a computer 212 to access the stored transaction data and review sets of data related to particular transactions that have been selectively stored in the database 192 for review. In some implementations, the user 212a can review data related to a transaction that was previously approved such as the transaction sought in FIG. 1. In the example of FIG. 1, the user 212a review data related to the transaction sought in the example of FIG. 1. By way of example, the user 212a can review the first image portion 115a that depicts an image of the physical identification document 102. In this example, the user 212a can determine that the first image portion 115a depicts a physical identification document 102 that is counterfeit. In such a scenario, the user 212a can use the computer 212 to instruct 230 the transaction verification system 150 to dynamically retrain itself.

Dynamically retraining the transaction verification system 150 can include the user 212a using the computer 212 to instruct the transaction verification system 150 to update one or more thresholds of the custom thresholds 164 applied by the comparison module 160 to interpret the transaction values of the transaction profile 162 generated by the transaction verification server 120 using the output data 152-1, 152-2, 152-3, 152-x generated by the transaction verification system 150. In the example of FIG. 1, the user 212a can essentially determine that threshold value 0.25 for determining whether output data 152-1, which is generated by the transaction verification module 150-1 based on processing input data 142a representing the first image portion 115a, is indicative of a transaction that should be approved is incorrect. Accordingly, the user 212a can instruct the transaction verification system 150 to dynamically retrain itself by adjusting a threshold of the transaction verification system based on a difference between the existing threshold and the predetermined error threshold. For example, in the example of FIG. 1, the transaction verification system 150 can update the threshold 0.25 to 0.30 so that the generated transaction value 152-1 that is produced by the transaction verification module 150-1 processing the input data 142a, or similarly related input data, would be outside of the error threshold (e.g., 0.26 would not be greater than 0.30) and classified as a denied transaction using the updated threshold.

In this scenario, if the physical identification document 102, or another physical identification document 102 having the same characteristics of the physical identification document 102, is presented as a form of identification during verification of a subsequent transaction, the system 100 can process an image of the physical document in the same manner described with reference to the example of FIG. 1, but now the re-trained system 100 can be configured to flag the transaction as a transaction for denial because the counterfeit document can be detected using the updated threshold 0.30 of the customer thresholds 164 (e.g., the score generated by the first transaction verification module 150-1 of 0.26 would not satisfy the newly trained threshold of 0.30). In some implementations, multiple thresholds can be updated based on user 212a review of the data related to a transaction. In addition, ultimate decisions by the system 100 to deny a subsequent transaction would need to be consistent with the decisioning logic 170 employed by the system, which the user 212a can also cause to be updated during dynamic retraining.

The examples of thresholds (e.g., 0.25), changes to thresholds (e.g., 0.25 being changed to 0.30), and transaction verification module outputs indicative of a potentially fraudulent transaction (e.g., 0.26) are used herein only for purposes of illustration. These values can be any values that a model is trained to produce or any threshold the system 100 is configured to apply and interpret in accordance with the functionality described by the present disclosure. None of these particular thresholds are intended to be limit the scope of the present disclosure to these particular values.

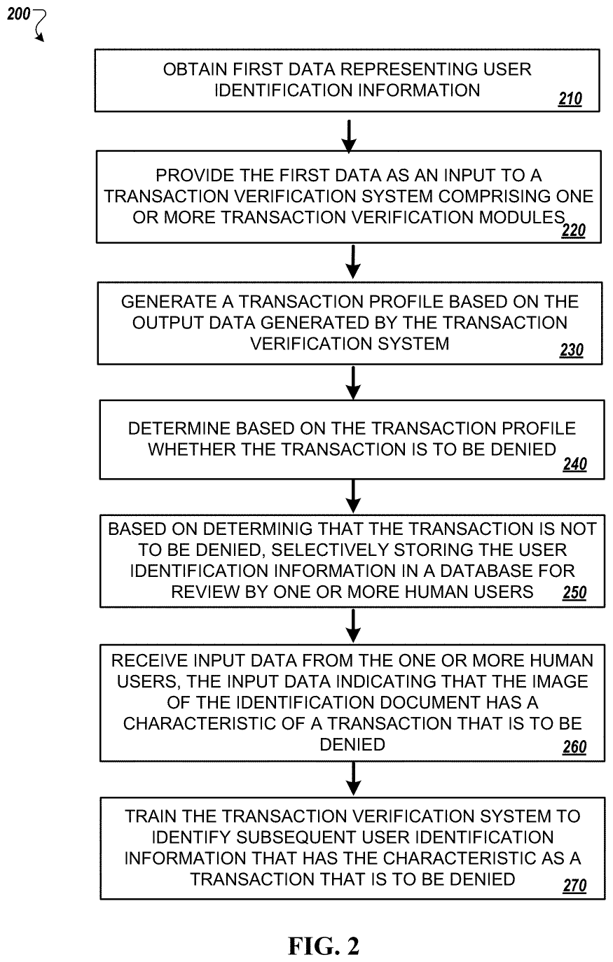

FIG. 2 is a flowchart of an example of a process 200 for dynamically re-training a flexible transaction verification system. In general, the process 200 can include obtaining, by the data processing system, first data representing user identification information, the user identification information comprising an image of an identification document (210), providing, by the data processing system, the first data as an input to a transaction verification system, the transaction verification system comprising one or more transaction verification modules that have each been trained to generate output data indicating whether data representing at least a portion of an input image depicts an identification document of an actor whose transaction is to be denied (220), generating, by the data processing system, a transaction profile based on the output data generated by the transaction verification system (230), determining, by the data processing system and based on the transaction profile, whether the transaction is to be denied (240), based on determining, by the data processing system and based on the transaction profile that the transaction is not to be denied, selectively storing, by the data processing system, the user identification information in a database for review by one or more human users (250), receiving, by the data processing system, input data from the one or more human users, the input data indicating that the image of the identification document has a characteristic of a transaction that is to be denied (260), and training, by the data processing system, the transaction verification system to identify subsequent user identification information that has the characteristic as a transaction that is to be denied (270).

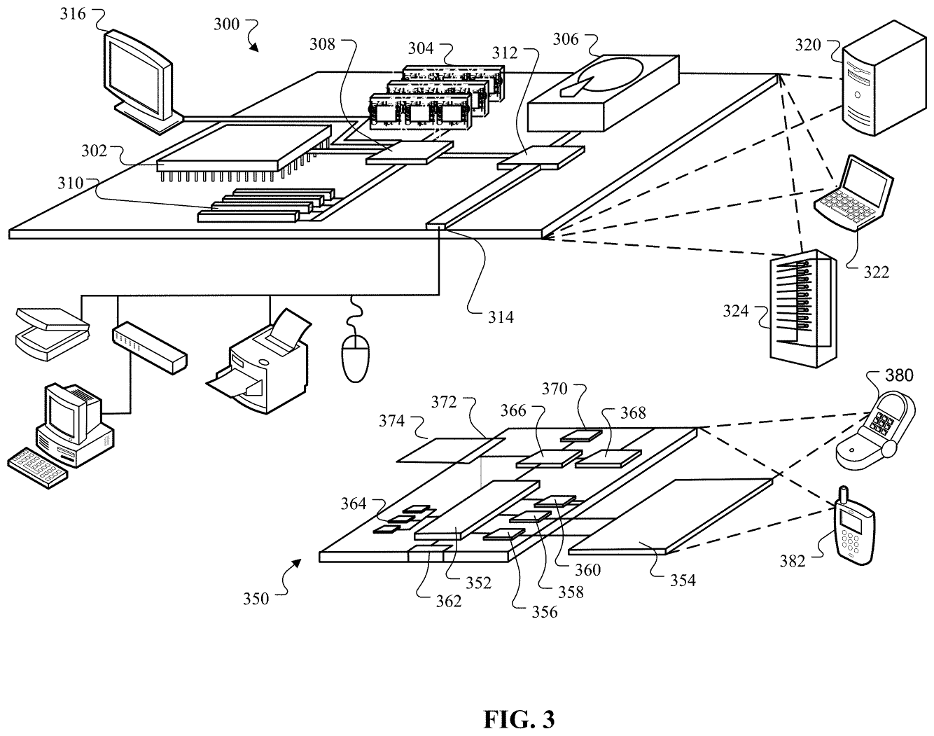

FIG. 3 is a block diagram of system components that can be used to implement a flexible transaction verification system.

Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, and other similar computing devices. Additionally, computing device 300 or 350 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and can be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses can be used, as appropriate, along with multiple memories and types of memory. Also, multiple computing devices 300 can be connected, with each device providing portions of the necessary operations, e.g., as a server bank, a group of blade servers, or a multi-processor system.

The memory 304 stores information within the computing device 300. In one implementation, the memory 304 is a volatile memory unit or units. In another implementation, the memory 304 is a non-volatile memory unit or units. The memory 304 can also be another form of computer-readable medium, such as a magnetic or optical disk.

The storage device 306 is capable of providing mass storage for the computing device 300. In one implementation, the storage device 306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth intensive operations. Such allocation of functions is exemplary only. In one implementation, the high-speed controller 308 is coupled to memory 304, display 316, e.g., through a graphics processor or accelerator, and to high-speed expansion ports 310, which can accept various expansion cards (not shown). In the implementation, low-speed controller 312 is coupled to storage device 306 and low-speed expansion port 314. The low-speed expansion port, which can include various communication ports, e.g., USB, Bluetooth, Ethernet, wireless Ethernet can be coupled to one or more input/output devices, such as a keyboard, a pointing device, microphone/speaker pair, a scanner, or a networking device such as a switch or router, e.g., through a network adapter. The computing device 300 can be implemented in a number of different forms, as shown in the figure. For example, it can be implemented as a standard server 320, or multiple times in a group of such servers. It can also be implemented as part of a rack server system 324. In addition, it can be implemented in a personal computer such as a laptop computer 322. Alternatively, components from computing device 300 can be combined with other components in a mobile device (not shown), such as device 350. Each of such devices can contain one or more of computing device 300, 350, and an entire system can be made up of multiple computing devices 300, 350 communicating with each other.

The computing device 300 can be implemented in a number of different forms, as shown in the figure. For example, it can be implemented as a standard server 320, or multiple times in a group of such servers. It can also be implemented as part of a rack server system 324. In addition, it can be implemented in a personal computer such as a laptop computer 322. Alternatively, components from computing device 300 can be combined with other components in a mobile device (not shown), such as device 350. Each of such devices can contain one or more of computing device 300, 350, and an entire system can be made up of multiple computing devices 300, 350 communicating with each other.

Computing device 350 includes a processor 352, memory 364, and an input/output device such as a display 354, a communication interface 366, and a transceiver 368, among other components. The device 350 can also be provided with a storage device, such as a micro-drive or other device, to provide additional storage. Each of the components 350, 352, 364, 354, 366, and 368, are interconnected using various buses, and several of the components can be mounted on a common motherboard or in other manners as appropriate.

The processor 352 can execute instructions within the computing device 350, including instructions stored in the memory 364. The processor can be implemented as a chipset of chips that include separate and multiple analog and digital processors. Additionally, the processor can be implemented using any of a number of architectures. For example, the processor 310 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 350, such as control of user interfaces, applications run by device 350, and wireless communication by device 350.

Processor 352 can communicate with a user through control interface 358 and display interface 356 coupled to a display 354. The display 354 can be, for example, a TFT (Thin-Film-Transistor Liquid Crystal Display) display or an OLED (Organic Light Emitting Diode) display, or other appropriate display technology. The display interface 356 can comprise appropriate circuitry for driving the display 354 to present graphical and other information to a user. The control interface 358 can receive commands from a user and convert them for submission to the processor 352. In addition, an external interface 362 can be provide in communication with processor 352, so as to enable near area communication of device 350 with other devices. External interface 362 can provide, for example, for wired communication in some implementations, or for wireless communication in other implementations, and multiple interfaces can also be used.

The memory 364 stores information within the computing device 350. The memory 364 can be implemented as one or more of a computer-readable medium or media, a volatile memory unit or units, or a non-volatile memory unit or units. Expansion memory 374 can also be provided and connected to device 350 through expansion interface 372, which can include, for example, a SIMM (Single In Line Memory Module) card interface. Such expansion memory 374 can provide extra storage space for device 350, or can also store applications or other information for device 350. Specifically, expansion memory 374 can include instructions to carry out or supplement the processes described above, and can include secure information also. Thus, for example, expansion memory 374 can be provide as a security module for device 350, and can be programmed with instructions that permit secure use of device 350. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352 that can be received, for example, over transceiver 368 or external interface 362.

Device 350 can communicate wirelessly through communication interface 366, which can include digital signal processing circuitry where necessary. Communication interface 366 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 368. In addition, short-range communication can occur, such as using a Bluetooth, Wi-Fi, or other such transceiver (not shown). In addition, GPS (Global Positioning System) receiver module 370 can provide additional navigation- and location-related wireless data to device 350, which can be used as appropriate by applications running on device 350.

Device 350 can also communicate audibly using audio codec 360, which can receive spoken information from a user and convert it to usable digital information. Audio codec 360 can likewise generate audible sound for a user, such as through a speaker, e.g., in a handset of device 350. Such sound can include sound from voice telephone calls, can include recorded sound, e.g., voice messages, music files, etc. and can also include sound generated by applications operating on device 350.

The computing device 350 can be implemented in a number of different forms, as shown in the figure. For example, it can be implemented as a cellular telephone 380. It can also be implemented as part of a smartphone 382, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

### OTHER EMBODIMENTS

A number of embodiments have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A data processing system for transaction verification, comprising:
one or more computers and one or more storage devices storing instructions that, when executed by the one or more computers, cause the one or more computers to perform operations comprising:
obtaining, by the data processing system, first data representing user identification information, the user identification information comprising an image of an identification document;
providing, by the data processing system, the first data as an input to a transaction verification system, the transaction verification system comprising one or more transaction verification modules that have each been trained to generate output data indicating whether data representing at least a portion of an input image depicts an identification document of an actor whose transaction is to be denied;
generating, by the data processing system, a transaction profile based on the output data generated by the transaction verification system;
determining, by the data processing system and based on the transaction profile, whether the transaction is to be denied;
based on determining, by the data processing system and based on the transaction profile that the transaction is not to be denied, selectively storing, by the data processing system, the user identification information in a database for review by one or more human users;
receiving, by the data processing system, input data from the one or more human users, wherein the input data indicates that the image of the identification document has a characteristic of a transaction that is to be denied; and
training, by the data processing system, the transaction verification system to identify subsequent user identification information that has the characteristic as identifying a person whose transaction is to be denied.

2. The system of claim 1, wherein the identification document is a document that includes an image of a person, wherein the identification document comprises (i) a driver's license, (ii) a passport, or (iii) other document that depicts an image of the person or other information that can identify the person.

3. The data processing system of claim 1, wherein the user identification information further includes one or more of a selfie image, device data, biometric information, or behavioral information.

4. The data processing system of claim 1, wherein selectively storing, by the data processing system, the user identification information in a database for review by one or more human users comprises:
determining, by the data processing system, that at least one value in the transaction profile is within a predetermined range for review; and
based on determining, that the at least one value is within the predetermined range for review, storing the user identification information in the database for review by one or more human users.

5. The data processing system of claim 4, wherein training, by the data processing system, the transaction verification system to identify subsequent user identification information that has the characteristic as identifying a person whose transaction is to be denied comprises:
adjusting a threshold of the machine learning model based on a difference between the threshold and the predetermined range for review.

6. The data processing system of claim 1, wherein selectively storing, by the data processing system, the user identification information in a database for review by one or more human users comprises:
determining, by the data processing system, that there is not at least one value in the transaction profile that is within a predetermined range for review; and
based on determining that there is not at least one value in the transaction profile that is within the predetermined range for review, determining to not store the user identification information in the database for review by one or more human users.

7. A method for transaction verification, the method comprising:
obtaining, by the data processing system, first data representing user identification information, the user identification information comprising an image of an identification document;
providing, by the data processing system, the first data as an input to a transaction verification system, the transaction verification system comprising one or more transaction verification modules that have each been trained to generate output data indicating whether data representing at least a portion of an input image depicts an identification document of an actor whose transaction is to be denied;
generating, by the data processing system, a transaction profile based on the output data generated by the transaction verification system;
determining, by the data processing system and based on the transaction profile, whether the transaction is to be denied;
based on determining, by the data processing system and based on the transaction profile that the transaction is not to be denied, selectively storing, by the data processing system, the user identification information in a database for review by one or more human users;
receiving, by the data processing system, input data from the one or more human users, the input data indicating that the image of the identification document has a characteristic of a transaction that is to be denied; and
training, by the data processing system, the transaction verification system to identify subsequent user identification information that has the characteristic as identifying a person whose transaction is to be denied.

8. The method of claim 7, wherein the identification document is a document that includes an image of a person, wherein the identification document comprises (i) a driver's license, (ii) a passport, or (iii) other document that depicts an image of the person or other information that can identify the person.

9. The method of claim 7, wherein the user identification information further includes one or more of a selfie image, device data, biometric information, or behavioral information.

10. The method of claim 7, wherein selectively storing, by the data processing system, the user identification information in a database for review by one or more human users comprises:
determining, by the data processing system, that at least one value in the transaction profile is within a predetermined range for review; and
based on determining, that the at least one value is within the predetermined range for review, storing the user identification information in the database for review by one or more human users.

11. The method of claim 10, wherein training, by the data processing system, the transaction verification system to identify subsequent user identification information that has the characteristic as identifying a person whose transaction is to be denied comprises:
adjusting a threshold of the machine learning model based on a difference between the threshold and the predetermined range for review.

12. The method of claim 7, wherein selectively storing, by the data processing system, the user identification information in a database for review by one or more human users comprises:
determining, by the data processing system, that there is not at least one value in the transaction profile that is within a predetermined range for review; and
based on determining that there is not at least one value in the transaction profile that is within the predetermined range for review, determining to not store the user identification information in the database for review by one or more human users.

13. A non-transitory computer-readable medium storing software comprising instructions executable by one or more computers which, upon such execution, cause the one or more computers to perform operations comprising:
obtaining, by the data processing system, first data representing user identification information, the user identification information comprising an image of an identification document;
providing, by the data processing system, the first data as an input to a transaction verification system, the transaction verification system comprising one or more transaction verification modules that have each been trained to generate output data indicating whether data representing at least a portion of an input image depicts an identification document of an actor whose transaction is to be denied;
generating, by the data processing system, a transaction profile based on the output data generated by the transaction verification system;
determining, by the data processing system and based on the transaction profile, whether the transaction is to be denied;
based on determining, by the data processing system and based on the transaction profile that the transaction is not to be denied, selectively storing, by the data processing system, the user identification information in a database for review by one or more human users;
receiving, by the data processing system, input data from the one or more human users, the input data indicating that the image of the identification document has a characteristic of a transaction that is to be denied; and
training, by the data processing system, the transaction verification system to identify subsequent user identification information that has the characteristic as identifying a person whose transaction is to be denied.

14. The computer-readable medium of claim 13, wherein the identification document is a document that includes an image of a person comprises (i) a driver's license, (ii) a passport, or (iii) other document that depicts an image of the person or other information that can identify the person.

15. The computer-readable medium of claim 13, wherein the user identification information further includes one or more of a selfie image, device data, biometric information, or behavioral information.

16. The computer-readable medium of claim 13, wherein selectively storing, by the data processing system, the user identification information in a database for review by one or more human users comprises:
determining, by the data processing system, that at least one value in the transaction profile is within a predetermined range for review; and
based on determining, that the at least one value is within the predetermined range for review, storing the user identification information in the database for review by one or more human users.

17. The computer-readable medium of claim 16, wherein training, by the data processing system, the transaction verification system to identify subsequent user identification information that has the characteristic as identifying a person whose transaction is to be denied comprises:
adjusting a threshold of the machine learning model based on a difference between the threshold and the predetermined range for review.

18. The computer-readable medium of claim 13, wherein selectively storing, by the data processing system, the user identification information in a database for review by one or more human users comprises:
determining, by the data processing system, that there is not at least one value in the transaction profile that is within a predetermined range for review; and
based on determining that there is not at least one value in the transaction profile that is within the predetermined range for review, determining to not store the user identification information in the database for review by one or more human users.
